(19) United States
(12) Patent Application Publication
(10) Pub. No.: US 2014/0255128 A1
(43) Pub. Date: Sep. 11, 2014

(54) BINDING SYSTEM USING A RELEASABLE FASTENING STRIP

(71) Applicants: Richard William Bauer, JR., Webster, NY (US); Robert Fredric Mindler, Churchville, NY (US)

(72) Inventors: Richard William Bauer, JR., Webster, NY (US); Robert Fredric Mindler, Churchville, NY (US)

(21) Appl. No.: 13/786,512

(22) Filed: Mar. 6, 2013

(51) Int. Cl. B42F 5/00

(52) U.S. Cl. CPC B42F 5/00
USPC 412/34

(57) ABSTRACT

A binding system for binding a set of media sheets using a binding strip and a plurality of pinching devices adapted to fasten together the binding strip and the set of media sheets by pinching them together in their respective spine portions. The binding strip includes a spine portion, a wraparound portion and a fastening portion having a releasable fastening strip. The binding system is adapted to bind the set of media sheets by aligning the spine edges of the set of media sheets and the binding strip, using the pinching devices to fasten together the set of media sheets and the binding strip along the spine edges, wrapping the wraparound portion of the binding strip around the spine edges of the fastened media sheets, and bringing the releasable fastening strip into operative contact with the back media sheet.

### CROSS-REFERENCE TO RELATED APPLICATIONS

Reference is made to commonly-assigned, co-pending U.S. patent application Ser. No. 13/558,776 (docket K001176), entitled “Producing bound document having inner cover sheet,” by C. White et al.; to commonly-assigned, co-pending U.S. patent application Ser. No. 13/627,217 (docket K001223), entitled: “Binding Strip including spacer,” by Y. No et al.; to commonly-assigned, co-pending U.S. patent application Ser. No. 13/627,266 (docket K001273), entitled: “Bound document having binding strip with spacer,” by Y. No et al.; and to commonly-assigned, co-pending U.S. patent application Ser. No. 13/627,303 (docket K001274), entitled: “Making bound document having fastener and spacer,” by Y. No et al., each of which is incorporated herein by reference.

### FIELD OF THE INVENTION

This invention pertains to the field of book binding and more particularly to a system for binding a set of sheets for a media sheets.

### BACKGROUND OF THE INVENTION

Books and photo albums are commonly assembled from single- and double-sided printed documents and photographs. Traditional bookbinding methods include gluing or stitching a set of pages together along one edge. The bound edge is then attached to a book cover, either directly, or through attachment to a spine sheet. A spine sheet spans the spine of the cover without being attached to it, and is adhered only to the two sides of the cover. The spine sheet permits a user to fully open a finished book because it flexes separately from the spine of the cover. The bound edges of the manuscript are glued to the spine sheet or cover, and the spine sheet is glued to the cover.

However, there is an increasing number of prints made at home, or in a retail establishment. Non-traditional book-makers, including specialty presses and retail photo lab operators, have a need for a process for binding materials that does not require the expensive equipment typically used in conventional bookbinding.

Clamp- and ring-type binders, such as three-ring binders, do not have the appearance and function of conventional soft or hard covered books. Furthermore, these binders require a margin be provided in which perforations or other mounting features can be punched or placed; this margin can occupy a considerable area that could otherwise be printed with content. Moreover, sheets in these binders are susceptible to damage that permits pages to fall out, possibly without detection.

U.S. Pat. No. 3,909,141 to Staats et al., entitled “Clamp binding,” describes a binding element having a flexible clamp with slots for the sheets. Although the cover is included, there are a limited number of slots, and a limited number of sheets can be inserted in each slot. Binding by this scheme is therefore limited in use, time-consuming, and tedious.

U.S. Pat. No. 5,061,139 to Zoltner, entitled “Method for applying hard and soft covers to bound or unbound documents,” discloses a bindery system for applying hard or soft covers to form bound books. The system includes a metal U-shaped channel which is bonded to the inside spine surface of the cover. Specialized equipment is used to crimp the U-shaped channel to bind the book pages.

A number of different binding systems have been proposed that utilize spring clamp mechanisms. U.S. Pat. No. 5,716,181 to Ebel, entitled “One piece self-binding system for binding documents,” discloses a binding system for use in a home environment that utilizes a spring binding to clamp pages into a bound book. A retaining piece is provided to hold the spring binding open until the pages are in place. The retaining piece is removed to clamp the pages into the book cover. U.S. Pat. No. 7,757,358 to Hoarau et al., entitled “Sheet retention mechanisms for spring clamp binders,” discloses a system for binding pages together using a spring clamp mechanism. U.S. Pat. No. 7,798,736 to Hoarau et al., entitled “Media binder arrangements,” discloses a media binder that includes spine clamps for securing the media pages. A tension sheet is used to transmit an opening force to the spine clamp. The components of such systems are generally too expensive and complex to be useful for producing low-cost photo books in a retail environment.

U.S. Pat. No. 6,685,415 to Rush et al., entitled “Bookbinding method,” describes an adhesive matrix with a release liner. A cover is adhered to exposed adhesive after the release liner is removed. However, this scheme can leave a noticeable offset (at least the thickness of the matrix) between the endpapers at either end of the book. This can be objectionable. It also requires using a fixture to heat the adhesive matrix to attach to the inner sheets.

U.S. Pat. No. 7,326,018 to Huotari, entitled “Method in glue-binding and a band for use in glue-binding,” describes a bundle of paper glue-bound to form a book. A glue band is wrapped around the bundle and heated to bind it. However, this scheme requires special equipment to wrap the glue band in a way that will not leave wrinkles or air bubbles in the band. Such wrinkles or bubbles would be perceptible to the touch of a person holding the book by the spine to read it, and could cause undesirable distraction or an impression of a lower-quality product.

Commonly-assigned U.S. Pat. No. 8,182,188 to Manico et al., entitled “Book and a method of making same,” which is incorporated herein by reference, describes an instant book binding system and book cover for rapidly binding single- or double-sided documents, photographs, pages, and other forms of hardcopy media into soft or hard cover books. The finished books retain the appearance and function of conventional mass produced soft and hard covered books. The method employs a book cover having a front cover, a back cover, and a spine section, wherein the spine section includes an adhesive strip having a release strip, the adhesive strip having a first side contacting the spine section. A first portion of a media clamp is attached on an inside surface of the front cover, and a second portion of the media clamp is attached on an inside surface of the back cover. The book cover is opened to expose the adhesive strip, and the assembled media is placed against the at least one release strip. The assembled media is clamped using the media clamp by closing the front cover and the back cover against the assembled media, and the release strip is pulled to remove it from between the adhesive strip and assembled media.

European patent document EP342957 by Dwyer et al., entitled “Binding system,” describes binding sheets together using a pressure-sensitive adhesive. However, this scheme uses an adhesive spine, so does not provide full wrap-around covers.

There remains for a low-cost method to bind a set of sheets to form an attractive and durable photo book without the need for special purpose equipment or highly-trained operators.

### SUMMARY OF THE INVENTION

The present invention represents a binding system for binding a set of media sheets including a front media sheet, a back media sheet, and one or more interior media sheets, each media sheet having a respective spine portion extending along a respective spine edge, comprising:

a binding strip having a spine edge and a free edge opposite to the spine-edge, the binding strip including:
a flexible substrate having an interior surface and an exterior surface, the flexible substrate including a spine portion extending along the spine edge, a fastening portion extending along the free edge, and a wraparound portion between the spine portion and the fastening portion; and
a first releasable fastening strip on the interior surface of the flexible substrate in the fastening portion, the first releasable fastening strip being adapted to releasably attach the binding strip to the back media sheet; and

a plurality of pinching devices adapted to fasten together the binding strip and the set of media sheets by pinching them together in their respective spine portions;

wherein when the binding system is adapted to bind the set of media sheets by:
aligning the spine edges of the set of media sheets and the binding strip, wherein the exterior surface of the binding strip faces an exterior surface of the front media sheet;
using the plurality of pinching devices to fasten together the set of media sheets and the binding strip in their respective spine portions;
wrapping the wraparound portion of the binding strip around the spine edges of the fastened media sheets; and
attaching the binding strip to the exterior surface of the back media sheet by bringing the first releasable fastening strip into operative contact with the fastening portion of the back media sheet, thereby providing a bound set of media sheets, wherein the first releasable fastening strip is adapted to be detached from the back media sheet and reattached to the back media sheet, thereby enabling one or more media sheets to be added to or removed from the bound set of media sheets.

This invention has the advantage that a bound book can easily be assembled without the need for specialized equipment or highly-skilled operators.

It has the additional advantage that the use of a releasable fastening strip enables media sheets to be added to or removed from the bound book at a later time after the book is initially bound.

### BRIEF DESCRIPTION OF THE DRAWINGS

FIGS. 1A-1B show a prior art binding system using a binding strip wrapped around a spine edge of a set of media sheets

FIGS. 2A-2G illustrate a binding system in accordance with the present invention;

FIGS. 3A-3B show a pinching device that can be in accordance with the present; and

FIGS. 4A-4C show an alternate pinching device that can be in accordance with the present.

The attached drawings are for purposes of illustration and are not necessarily to scale.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

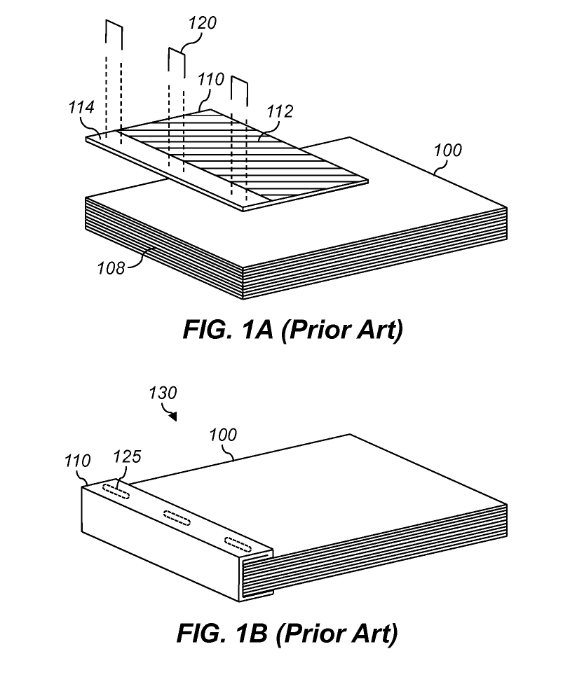

U.S. Patent Application Publication No. 2011/0278831 to Huotari et al., entitled “Binding back and a method for protecting the binding edge of a sheet block, as well as a binding formed from the sheet block and the binding back,” discloses a binding system similar to that illustrated in FIGS. 1A-1B where a binding strip 110, having an adhesive portion 112 and a non-adhesive portion 114, is aligned with a set of media sheets 100 along spine edge 108 and connected together using fasteners (e.g., staples 120). The adhesive portion 112 of the binding strip 110 is then wrapped around the spine edge 108 of the media sheets 100 and adhered to the spine edge 108 and the back side of the last media sheet 100, thereby providing bound media sheets 130. This approach has the disadvantage that the fasteners used to fasten the media sheets 100 and the binding strip 110 together can be perceived through the binding strip 110 by a person holding or looking at the bound media sheets 130 produced by this scheme. Fasteners generally protrude beyond the outer surfaces of the media sheets 100, producing raised bumps 125 under the folded-over binding strip 110 that can be seen or felt. This can produce a less professional impression than the impression produced by a professionally-bound book. Another disadvantage is that the set of media sheets 100 are permanently bound, making it impossible to remove or add media sheets at a later time.

Commonly-assigned U.S. Patent Application Publication No. 2012/0248753 to Mindler, entitled “Binder clip,” and the related U.S. Patent Application Publication No. 2012/0251269 to Mindler, entitled “Binder clip,” both of which are incorporated herein by reference, describe a binding system that can be used to bind printed media sheets into a book (e.g., a photo book). The binding system includes a binder clip having flexible sidewalls biased to close around a rigid retainer for securing pages wrapped around the retainer or pinched by the binder clip and retainer to manually form a book.

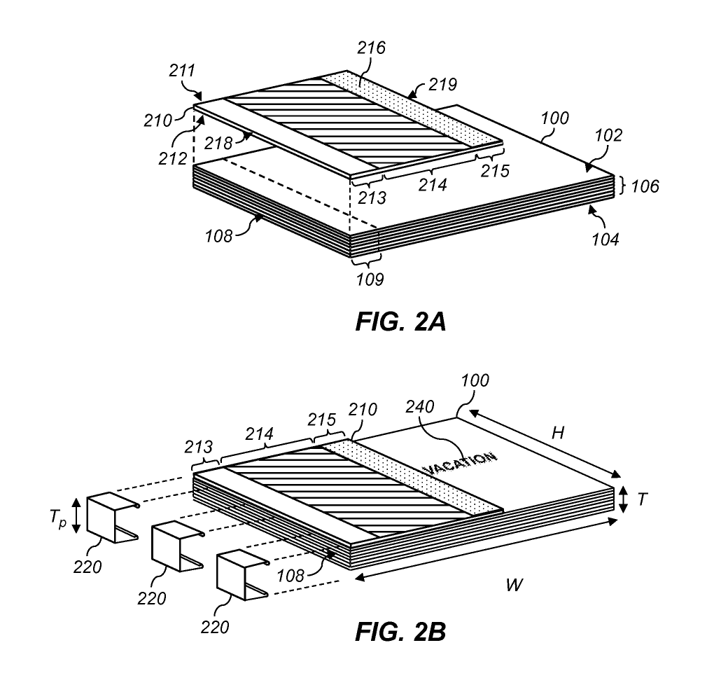

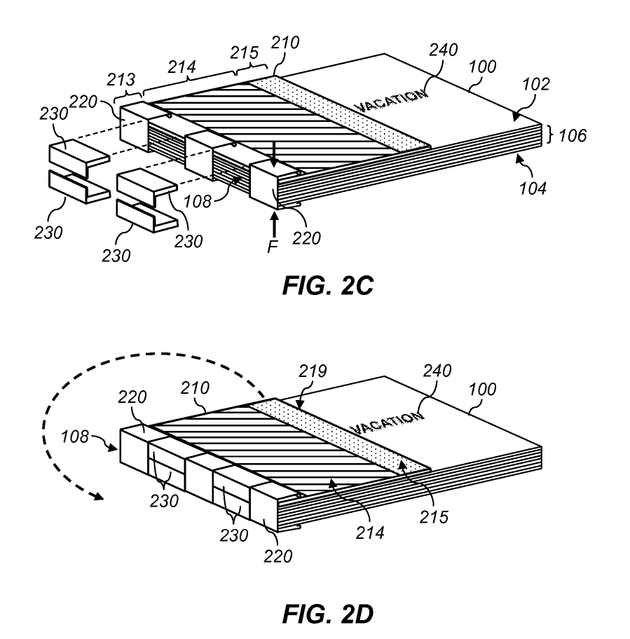

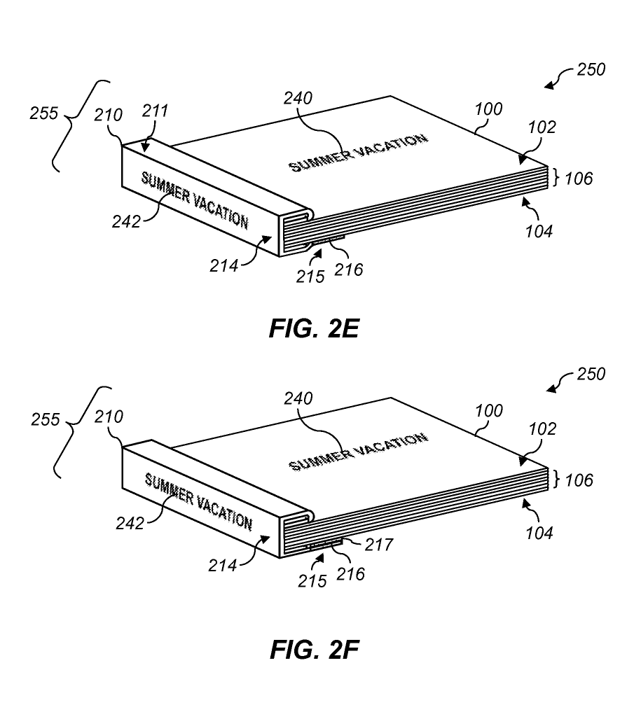

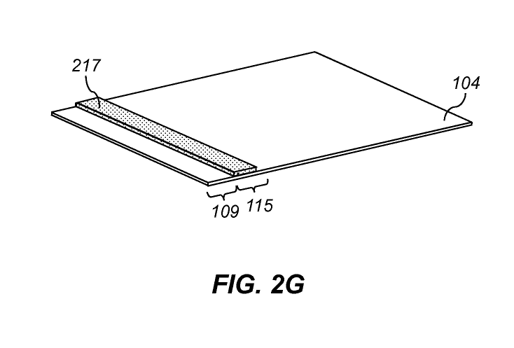

The present invention will now be described with reference to FIGS. 2A-2G, which illustrate a binding system for binding a set of media sheets 100, including a front media sheet 102, a back media sheet 104 and one or more interior media sheets 106. (The terms “front” and “back” are relative and do not constrain the orientation or content of the bound document or any sheet.) The binding system is adapted to bind the media sheets 100 in a spine portion 109, along spine edge 108. In a preferred embodiment, the interior media sheets 106 are pages of a photo book, and include photographic images and optionally other printed content such as text and graphics. The printed content can be provided using any printing technology known in the art such as electrophotographic printers, inkjet printers and thermal dye sublimation printers.

The front media sheet 102 and the back media sheet 104 are typically book covers and may be made from a different type of media stock than some or all of the interior media sheets 106. The front media sheet 102 can optionally include a book title 240 (see FIG. 2E), or other content such as text, graphics or photographic images. As shown in FIG. 2B, the media sheets 100 have a page height H, a page width W and combine to form a bound book 250 (FIG. 2E) having a total thickness T.

The binding system includes a plurality a binding strip 210 adapted to wrap around spine edge 102 of the set of media sheets 100. The binding strip 210 has a spine edge 218 and a free edge 219 opposite to the spine-edge 218. The binding strip 210 is formed using a flexible substrate and has an interior surface 211 and an exterior surface 212. (The “interior” and “exterior” qualifiers are used in the sense of the position of the surfaces when the binding strip 210 is wrapped around the spine edge 102.) The binding strip 210 includes three different regions: a spine portion 213 extending along the spine edge 218, a fastening portion 215 extending along the free edge 219, and a wraparound portion 214 between the spine portion 213 and the fastening portion 215. A releasable fastening strip 216 is provided on the interior surface 211 of the binding strip 210 in the fastening portion 215. As will be described in more detail below, the releasable fastening strip 216 is adapted to releasably attach the binding strip 210 to the back media sheet 104.

As shown in FIG. 2A, the first step in using the binding system is to align the spine edges 108 of the set of media sheets 100 with the spine edge 218 of the binding strip 210, with the exterior surface 212 of the binding strip 210 facing an exterior surface of the front media sheet 102.

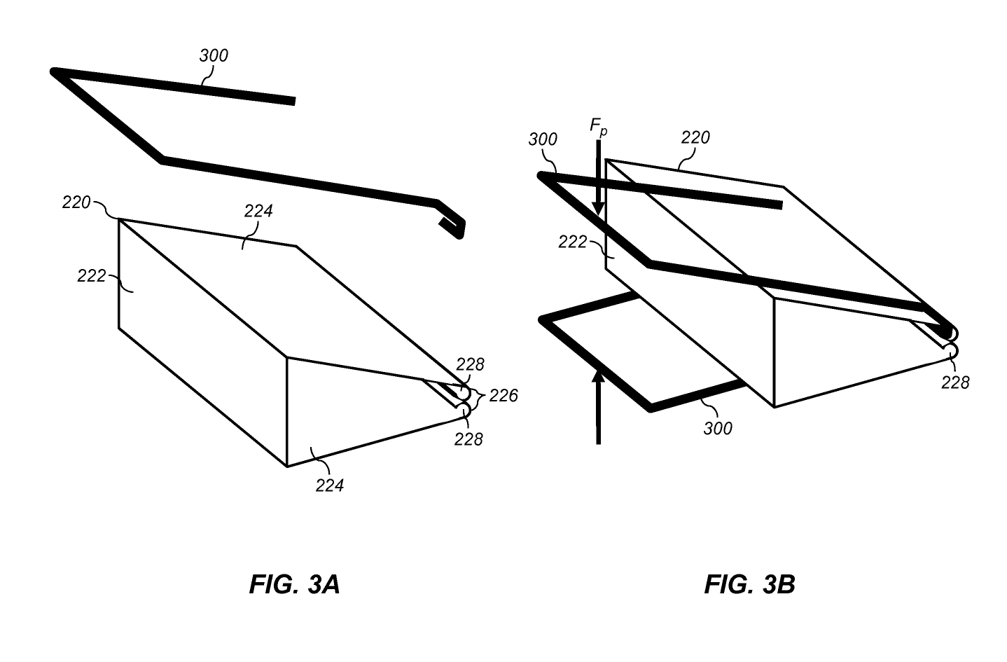

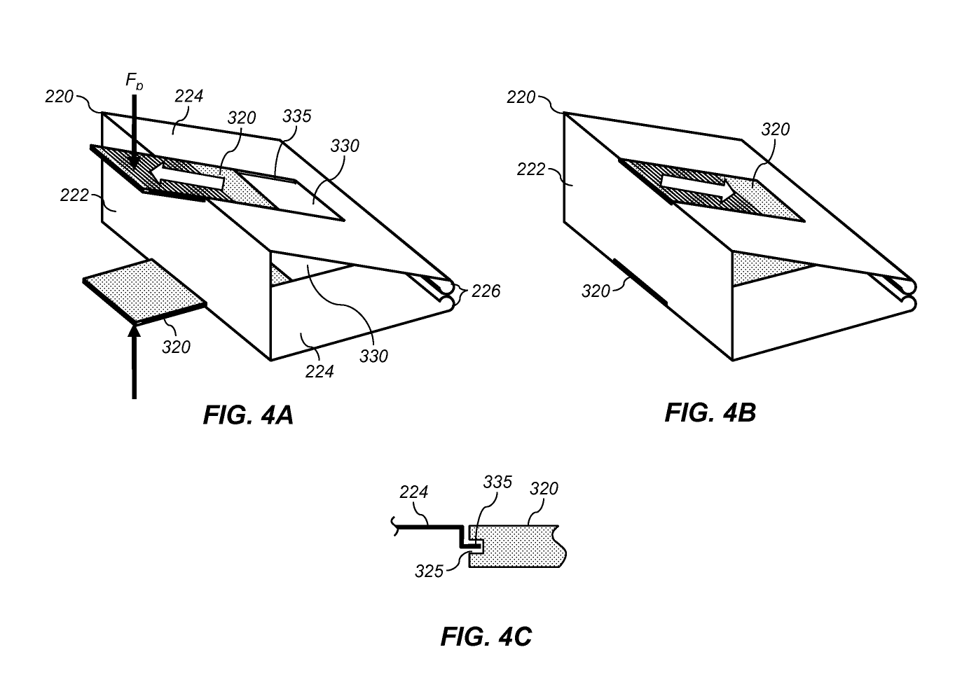

Next, a plurality of pinching devices 220 are used to fasten together the set of media sheets 100 and the binding strip 210 in their respective spine portions 109 and 213 as shown in FIG. 2B. The pinching devices 220 are adapted to fasten together the binding strip 210 and the set of media sheets 100 by pinching them together with a clamping force F (see FIG. 2C). Any appropriate type of pinching device 220 known in the art can be used in accordance with the present invention, including spring clips (e.g., “binder clips”) or clamping devices. In some embodiments, different size pinching devices 220 can be provided for use with different numbers of media sheets 100. In particular, the pinching device thickness Tₚ, corresponding to the height of the spine side of the pinching device 220 that covers the spine edge 108, can be varied according to the book thickness T. Generally, the pinching device thickness Tₚ should be slightly larger than the sum of the book thickness T and the thickness of the spine portion 213 of the binding strip 210. Exemplary pinching devices 220 that can be used in various embodiments will be described in more detail below with respect to FIGS. 3A-3B and FIGS. 4A-4C.

In a preferred embodiment, optional spacers are provided having exterior surface profiles substantially matching exterior surface profiles of the fastened pinching devices 220, wherein the spacers are inserted between the fastened pinching devices 220 around the spine edge 108 of the fastened media sheets 100. In FIG. 2C, exemplary spacers are shown as spacer halves 230. Two spacer halves 230 are inserted between each pair of adjacent pinching devices 220. A first spacer half 230 extends from the spine edge 108 over the spine portion 213 on the front media sheet 102 and a second spacer half 230 that extends from the spine edge 108 over the spine portion 213 on the back media sheet 104. When the first and second spacer halves 230 are inserted, they combine to provide an exterior surface profile that substantially matches the exterior surface profile of the fastened pinching devices 220, thereby providing exterior surfaces that are substantially flush as shown in FIG. 2D. The spacer halves 230 can be made out of any appropriate material such as plastic or metal. In some embodiments, different size spacer halves 230 can be provided for use with different book sizes (e.g., different page heights H or different book thicknesses H).

Next, the free edge 219 of the binding strip 210 is wrapped around the spine edges 108 of the fastened media sheets 100 as indicated by the dashed arrow in FIG. 2D. In this way, the wraparound portion 214 of the binding strip 210 is wrapped around the spine edges 108, with the interior surface 211 (FIG. 2A) of the wraparound portion 214 being in contact with the spine edges 108, and the exterior surface 212 (FIG. 2A) of the wraparound portion 214 being visible.

In the illustrated embodiment where the spacer halves 230 are added to provide substantially flush surfaces with the pinching devices 220, the wrapped binding strip 210 conforms to the flush surfaces so that the bound book 250 has a bound edge 255 with a substantially smooth look and feel as shown in FIG. 2E. Preferably, the flexible substrate of the binding strip 210 should have sufficient stiffness to hide any residual irregularities in the surfaces formed by the pinching devices 220 and the spacer halves 230 so that the exterior surface 212 of the wrapped binding strip 210 is smooth.

In cases where the optional spacers (e.g., spacer halves 230) are not used, the stiffness of the flexible substrate would need to be relatively high to cover over the gaps between the pinching devices 220 without producing noticeable valleys. In this case, it may be desirable to score the wraparound portion 214 of the binding strip along lines corresponding to the upper and lower edges of the wrapped spine edges so that the binding strip 210 will naturally fold at the appropriate locations.

In some embodiments, the binding strip 210 further includes a cushioning layer covering the interior surface 211 of the flexible substrate in the wraparound portion 214. The cushioning layer is adapted to conform to any residual irregularities in the surfaces formed by the pinching devices 220 and the spacer halves 230 so that the exterior surface 212 of the wrapped binding strip 210 is smooth.

The exterior surface 212 (FIG. 2A) of the wraparound portion 214 of the binding strip 210 will be visible when the binding strip 210 has been wrapped around the spine edge 108 of the fastened media sheets 100. Therefore, the appearance of the exterior surface 212 will control the appearance of the bound edge 255 (FIG. 2E) of the bound book 250. In some embodiments, the exterior surface 212 of the wraparound portion 214 of the binding strip 210 has a color, pattern, texture or material that matches (or is complementary to) the exterior surfaces of the front media sheet 102 (i.e., the front book cover) and the back media sheet 104 (i.e., the back book cover), thereby providing a consistent and aesthetically pleasing look for the cover of the bound book 250.

In some embodiments, a book title 242 can be provided in an appropriate location on exterior surface 212 of the wraparound portion 214 of the binding strip 210 so that the book title is visible on the spine of the bound book 250 as shown in FIG. 242. In some arrangements, the book title 242 can be printed onto an adhesive label which is affixed onto the binding strip 210. In this case, the adhesive label preferably has a clear substrate so that the color of the binding strip 210 is not obscured. Alternately, the book title 242 can be printed directly onto the binding strip 210.

Next, the binding strip 210 is attached to the exterior surface of the back media sheet 104 by bringing the releasable fastening strip 216 into operative contact with the back media sheet 104, thereby providing a bound set of media sheets 100 as shown in FIG. 2E. The first releasable fastening strip 216 is adapted to be detached from the back media sheet 104 and reattached to the back media sheet 104, thereby enabling one or more media sheets 100 to be added to or removed from the bound book 250.

In some embodiments, the releasable fastening strip 216 includes a pressure-sensitive adhesive that can be pressed against the back media sheet 104 to attach the binding strip 210 to the back media sheet 104. An example of a pressure-sensitive adhesive that can be used for this purpose is described in U.S. Pat. No. 5,491,012 to Luhmann et al., entitled “Use of a strip of an adhesive film for a re-releasable adhesive bond.” A protective release strip can be provided over the pressure-sensitive adhesive which can be removed by the user before the releasable fastening strip 216 is attached to the back media sheet 104.

In some embodiments, a pressure-sensitive adhesive can also be provided on the interior surface 211 of some or all of the wraparound portion 214 of the binding strip 210. In this way, the binding strip 210 can be releasably fastened to the spine edges 108 of the fastened media sheets of the fastened media sheets 100, providing a more stable binding. In some embodiments, the wraparound portion 214 and the fastening portion 215 can be covered with a single extended fastening strip 216.

An alternate arrangement is illustrated in FIG. 2F. In this case, the releasable fastening strip 216 is adapted to releasably fasten together with a second releasable fastening strip 217, which is provided on a fastening portion 115 of the exterior surface of the back media sheet 104, as shown in FIG. 2G. With this arrangement, the binding strip 210 is attached to the back media sheet 104 by pressing the releasable fastening strip 216 against the second releasable fastening strip 217, thereby fastening the releasable fastening strip 216 and the second releasable fastening strip 217 together. Any type of releasable fastening mechanisms known in the art can be used in accordance with the present invention. In some embodiments, the releasable fastening strip 216 and the second releasable fastening strip 217 can be hook and loop fastening strips, which are well-known in the art. Alternately, the releasable fastening strip 216 and the second releasable fastening strip 217 can each include an array of mushroom-shaped stems protruding from a substrate, where the mushroom-shaped stems on the releasable fastening strip 216 are adapted to interlock with the mushroom-shaped stems on the second releasable fastening strip 217. Examples of such fastening strips are the well-known Dual Lock Reclosable Fasteners available from 3M, and the similar Duotec fastening strips.

FIGS. 3A-3B illustrate additional details of an exemplary pinching device 220 that can be used in accordance with various embodiments of the present invention. In this case, the pinching device 220 uses a spring clip mechanism similar to well-known binder clips. The pinching device 220 has two clip faces 224 connected to a clip spine 222. The clip faces 224 have pressure edges 226 opposite to the clip spine 222. The clip faces 224 are flexibly biased toward each other such that the pressure edges 226 provide a pinching force F (FIG. 2C) when media sheets 100 are inserted between the clip faces 224.

Conventional binder clips typically include pivotable wire handles inserted into loops along the pressure edges 226 that can be used as levers to spread the clip faces 224 apart so that the media sheets 100 can be inserted. Such handles are undesirable for use in the present application because they will interfere with the binding strip 210. Furthermore, the loops provided along the pressure edges 226 are typically formed on the exterior surfaces of the clip faces, which would be undesirable for use in the present application because the exterior surface of the clip faces 224 would not be flat.

To overcome these disadvantages associated with conventional binder clip, the exemplary pinching device 220 of FIG. 3A includes loops 228 that are formed on the interior surfaces of the clip faces 224 so that the exterior surfaces can be substantially flat. Furthermore, removable levers 300 are provided that can be temporarily inserted into the loops 228 as shown in FIG. 3B. The levers 300 are preferably made from a stiff, heavy-gauge wire. When the levers 300 are attached to the pinching device 220, the user can squeeze the levers 300 together with a pinching force Fₚ to spread the clip faces 224 apart so that the media sheets 100 can be inserted. The levers 300 can then be pulled out of the loops 228 leaving the pinching device 220 in a fastened position as shown in FIG. 2C, where it will providing the clamping force F to fasten together the media sheets 100.

FIGS. 4A-4C illustrate an alternate pinching device 220 that can be used in accordance with various embodiments of the present invention. As with the pinching device 220 of FIG. 3A, the pinching device 220 has two clip faces 224 connected to a clip spine 222. The clip faces 224 have pressure edges 226 opposite to the clip spine 222, the clip faces 224 being flexibly biased toward each other such that the pressure edges 226 provide a pinching force F (FIG. 2C) when media sheets 100 are inserted between the clip faces 224.

In this case, each clip face 224 includes a retractable tab 320 that can be selectively slid in a direction parallel to the respective clip face 224 between a first tab position shown in FIG. 4A and a second tab position shown in FIG. 4B. When the retractable tabs 320 are in the first tab position, the retractable tabs 320 protrude past the clip spine 222, thereby enabling an operator to open the pinching device 220 by squeezing the protruding retractable tabs 224 together with pinching force Fₚ to spread apart the clip faces 224 so that the set of media sheets 100 can be inserted between the clip faces 224.

After the media sheets 100 have been inserted, the retractable tabs 320 can be slid to the second tab position such that they do not protrude past the clip spine 222 as shown in FIG. 4B. In some embodiments, the side edges of the retractable tables 320 have grooves 325, as shown in the enlarged cross-sectional view of FIG. 4C. The grooves 325 are adapted to ride along lips 335 provided along the side edges of a rectangular opening 330 in each of the clip faces 224. Preferably, the exterior surfaces of the retractable tabs 320 are co-planar with the exterior surfaces of the respective clip faces 224, thereby providing a substantially flat surface when the retractable tabs 320 are in the second tab position. This has the advantage that the exterior profile of the fastened pinching devices 220 is consistent, so that there will be no bumps in the wrapped binding strip 210 (FIG. 2E).

The invention has been described in detail with particular reference to certain preferred aspects thereof, but it will be understood that variations, combinations, and modifications can be effected by a person of ordinary skill in the art within the spirit and scope of the invention.

### PARTS LIST

100 media sheets
102 front media sheet
104 back media sheet
106 interior media sheets
108 spine edge
109 spine portion
110 binding strip
112 adhesive portion
114 non-adhesive portion
115 fastening portion
120 staples
125 raised bumps
130 bound media sheets
210 binding strip
211 interior surface
212 exterior surface
213 spine portion
214 wraparound portion
215 fastening portion
216 releasable fastening strip
217 second releasable fastening strip
218 spine edge
219 free edge
220 pinching device
222 clip spine
224 clip face
226 pressure edge
228 loop
230 spacer halves
240 book title
242 book title
250 bound book
255 bound edge
300 lever
320 retractable tab
325 groove
330 opening
335 lip
F clamping force
Fₚ pinching force
H page height
T book thickness
T_{P} pinching device thickness
W page width

1. A binding system for binding a set of media sheets including a front media sheet, a back media sheet, and one or more interior media sheets, each media sheet having a respective spine portion extending along a respective spine edge, comprising:
a binding strip having a spine edge and a free edge opposite to the spine-edge, the binding strip including:
a flexible substrate having an interior surface and an exterior surface, the flexible substrate including a spine portion extending along the spine edge, a fastening portion extending along the free edge, and a wraparound portion between the spine portion and the fastening portion; and
a first releasable fastening strip on the interior surface of the flexible substrate in the fastening portion, the first releasable fastening strip being adapted to releasably attach the binding strip to the back media sheet; and
a plurality of pinching devices adapted to fasten together the binding strip and the set of media sheets by pinching them together in their respective spine portions;
wherein when the binding system is adapted to bind the set of media sheets by:
aligning the spine edges of the set of media sheets and the binding strip, wherein the exterior surface of the binding strip faces an exterior surface of the front media sheet;
using the plurality of pinching devices to fasten together the set of media sheets and the binding strip in their respective spine portions;
wrapping the wraparound portion of the binding strip around the spine edges of the fastened media sheets; and
attaching the binding strip to the exterior surface of the back media sheet by bringing the first releasable fastening strip into operative contact with the fastening portion of the back media sheet, thereby providing a bound set of media sheets, wherein the first releasable fastening strip is adapted to be detached from the back media sheet and reattached to the back media sheet, thereby enabling one or more media sheets to be added to or removed from the bound set of media sheets.

2. The binding system of claim 1 further including one or more spacers having exterior surface profiles substantially matching exterior surface profiles of the fastened pinching devices, wherein the spacers are inserted between the fastened pinching devices around the spine edges of the fastened media sheets before the binding strip is wrapped around the spine edges of the fastened media sheets.

3. The binding system of claim 2 wherein the spacers include a first spacer half that extends from the spine edge over the spine portion on the front media sheet and a second spacer half that extends from the spine edge over the spine portion on the back media sheet, and wherein the first and second spacer halves combine to provide the exterior surface profile that substantially matches the exterior surface profile of the fastened pinching device.

4. The binding system of claim 1 wherein the first releasable fastening strip includes a pressure-sensitive adhesive, and wherein the attaching step includes pressing the pressure-sensitive adhesive onto the fastening portion of the back media sheet.

5. The binding system of claim 1 further including a second releasable fastening strip on the exterior surface of the back media sheet in the fastening portion, the second releasable fasting strip being adapted to fasten together with the first releasable fastening strip, and wherein the attaching step includes pressing the first releasable fastening strip against the second releasable fastening strip thereby fastening the first and second fastening strips together.

6. The binding system of claim 5 wherein the first and second releasable fastening strips are hook and loop fastening strips.

7. The binding system of claim 5 wherein the first and second releasable fastening strips each include an array of mushroom-shaped stems protruding from a substrate, the mushroom-shaped stems on the first releasable fastening strip being adapted to interlock with the mushroom-shaped stems on the second releasable fastening strip.

8. The binding system of claim 1 wherein the pinching devices are spring clips, each having two clip faces connected by a clip spine, each clip face including a pressure edge opposite the clip spine, the clip faces being flexibly biased toward each other such that the pressure edges provide a pinching force when media sheets are inserted between the clip faces.

9. The binding system of claim 8 wherein each clip face includes a retractable tab that can be selectively slid in a direction parallel to the respective clip face between first and second tab positions, such that when the retractable tabs are in the first tab position the retractable tabs protrude past the clip spine thereby enabling an operator to open the pinching device by squeezing the protruding retractable tabs together so that the set of media sheets can be inserted between the clip faces, and when the retractable tabs are in the second tab position the retractable tabs are retracted such that they do not protrude past the clip spine.

10. The binding system of claim 9 wherein the exterior surfaces of the retractable tabs are substantially co-planar with exterior surfaces of the respective clip faces.

11. The binding system of claim 1 wherein the exterior surface of the binding strip has a color, pattern, texture or material that matches the front and back media sheets, or is complementary to the front and back media sheets.

12. The binding system of claim 1 wherein the binding strip further includes pressure-sensitive adhesive on the interior surface of the flexible substrate in the wraparound portion for attaching the binding strip to the spine edges of the fastened media sheets.

13. The binding system of claim 1 wherein the binding strip further includes a cushioning layer covering the interior surface of the flexible substrate in the wraparound portion, the cushioning layer being adapted to conform to any irregularities in the spine edges and spine portions of the fastened media sheets so that the exterior surface of the wrapped binding strip is smooth.

14. The binding system of claim 1 wherein the flexible substrate has sufficient stiffness to hide any irregularities in the spine edges and spine portions of the fastened media sheets so that the exterior surface of the wrapped binding strip is smooth.
